(19) United States
(12) Patent Application Publication
(10) Pub. No.: US 2021/0381372 A1
(43) Pub. Date: Dec. 9, 2021

(54) INNOVATIVE APPROACH FOR PULSED NEUTRON AND ARRAY SPINNER MEASUREMENTS INTERPRETATION

(71) Applicant: Saudi Arabian Oil Company, Dhahran (SA)

(72) Inventors: Noureddine Benlakhdar, Dhahran (SA); Mamdouh N. Al-Nasser, Dammam (SA)

(21) Appl. No.: 16/891,318

(22) Filed: Jun. 3, 2020

(51) Int. Cl. E21B 47/26; E21B 47/12; E21B 47/026

(52) U.S. Cl. CPC E21B 47/26; E21B 47/026; E21B 47/138

(57) ABSTRACT

The present disclosure describes a method for surveillance of a horizontal well, including: monitoring a first set of measurement data from a pulsed neutron tool and a second set of measurement data from an array tool, wherein: the first set of measurement data indicate a holdup of the second liquid globally inside the horizontal well, and the second set of measurement data show a plurality of velocities measured at a set of corresponding locations inside the horizontal well; and interpolating the first set of measurement data to identify an interface between the first liquid and the second liquid; establish an estimated holdup of the second liquid in the cross-section of the horizontal well; and combining the estimated holdup of the second liquid with velocities measured at locations inside the horizontal well that correspond to the second layer to generate a flow weighted estimate of the second liquid inside the horizontal well.

### TECHNICAL FIELD

This disclosure generally relates to the surveillance production reservoirs and wells.

### BACKGROUND

Exploring, drilling and harvesting hydrocarbon and other wells are generally complicated, time consuming and ultimately very expensive endeavors. In recognition of these expenses, additional emphasis has been placed on the surveillance of production reservoirs and wells over the life time of the production reservoirs and wells.

### SUMMARY

In one aspect, the present disclosure describes a computer-implemented method for surveillance of a horizontal well, including: monitoring a first set of measurement data from a pulsed neutron tool and a second set of measurement data from an array tool, wherein: the horizontal well includes a first liquid in a first layer and a second liquid in a second layer that is below the first layer, the first set of measurement data indicate a holdup of the second liquid globally inside the horizontal well, and the second set of measurement data show a plurality of velocities measured at a set of corresponding locations inside the horizontal well; and interpolating the first set of measurement data to identify an interface in a cross-section of the horizontal well, wherein the interface is between the first layer and the second layer; based on the interface, establish an estimated holdup of the second liquid locally in the cross-section of the horizontal well; and combining the estimated holdup of the second liquid with velocities measured at locations inside the horizontal well that correspond to the second layer to generate a flow weighted estimate of the second liquid inside the horizontal well.

Implementations may include one or more of the following features.

Some implementations may further include: based on the interface, establishing an estimated holdup of the first liquid in the cross-section of the horizontal well. The implementations may further include: combining the estimated holdup of the first liquid with velocities measured at locations inside the horizontal well that correspond to the first layer to generate a flow weighted estimate of the first liquid inside the horizontal well. The implementations may further include: supplementing a production log with the flow weighted estimate of the second liquid inside the horizontal well and the flow weighted estimate of the first liquid inside the horizontal well.

Some implementations may further include: supplementing a production log with the flow weighted estimate of the second liquid inside the horizontal well.

Interpolating the first set of measurement data may further include: dividing the cross-section of the horizontal well into a plurality of segments; and fitting the first set of measurement data according to the plurality of segments such that the interface matches a profile of the first set of measurement data. The plurality of segments may be evenly spaced. The fitting may include at least one non-linear fitting.

The horizontal well may further includes a third liquid in a third layer that is above the first layer or below the second layer. Some implementations may further include: interpolating the first set of measurement data to identify an interface, wherein the interface is either between the first layer and the third layer, or between the second layer and the third layer; based on the interface, establishing an estimated holdup of the third liquid in the cross-section of the horizontal well; and combining the estimated holdup of the third liquid with velocities measured at locations inside the horizontal well that correspond to the third layer to generate a flow weighted estimate of the third liquid inside the horizontal well.

The array tool may include a spinner array tool with a multitude of sensors.

In another aspect, the present disclosure describes a computer system including one or more processors configured to perform operations of: monitoring a first set of measurement data from a pulsed neutron tool and a second set of measurement data from an array tool, wherein: a horizontal well includes a first liquid in a first layer and a second liquid in a second layer that is below the first layer, the first set of measurement data indicate a holdup of the second liquid globally inside the horizontal well, and the second set of measurement data show a plurality of velocities measured at a set of corresponding locations inside the horizontal well, and interpolating the first set of measurement data to identify an interface in a cross-section of the horizontal well, wherein the interface is between the first layer and the second layer; based on the interface, establish an estimated holdup of the second liquid locally in the cross-section of the horizontal well; and combining the estimated holdup of the second liquid with velocities measured at locations inside the horizontal well that correspond to the second layer to generate a flow weighted estimate of the second liquid inside the horizontal well.

Implementations may include one or more of the following features.

Some implementations may further include: based on the interface, establishing an estimated holdup of the first liquid in the cross-section of the horizontal well. The implementations may further include: combining the estimated holdup of the first liquid with velocities measured at locations inside the horizontal well that correspond to the first layer to generate a flow weighted estimate of the first liquid inside the horizontal well. The implementations may further include: supplementing a production log with the flow weighted estimate of the second liquid inside the horizontal well and the flow weighted estimate of the first liquid inside the horizontal well.

Some implementations may further include: supplementing a production log with the flow weighted estimate of the second liquid inside the horizontal well.

Interpolating the first set of measurement data may further include: dividing the cross-section of the horizontal well into a plurality of segments; and fitting the first set of measurement data according to the plurality of segments such that the interface matches a profile of the first set of measurement data. The plurality of segments may be evenly spaced. The fitting may include at least one non-linear fitting.

The horizontal well may further includes a third liquid in a third layer that is above the first layer or below the second layer. Some implementations may further include: interpolating the first set of measurement data to identify an interface, wherein the interface is either between the first layer and the third layer, or between the second layer and the third layer; based on the interface, establishing an estimated holdup of the third liquid in the cross-section of the horizontal well; and combining the estimated holdup of the third liquid with velocities measured at locations inside the horizontal well that correspond to the third layer to generate a flow weighted estimate of the third liquid inside the horizontal well.

The array tool may include a spinner array tool with a multitude of sensors.

Implementations according to the present disclosure may be realized in computer implemented methods, hardware computing systems, and tangible computer readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The details of one or more implementations of the subject matter of this specification are set forth in the description, the claims, and the accompanying drawings. Other features, aspects, and advantages of the subject matter will become apparent from the description, the claims, and the accompanying drawings.

### DESCRIPTION OF DRAWINGS

FIG. 1 illustrates an example of a flow chart for monitor a production reservoir/well according to an implementation of the present disclosure.

FIGS. 2A to 2C shows examples of diagrams to illustrate converting the global holdup measurement into a more localized array holdup estimate according to an implementation of the present disclosure.

FIGS. 2D and 2E illustrates examples of combining pulsed neutron logging (PNL) with spinner array tool (SAT) according to an implementation of the present disclosure.

FIG. 3 illustrates examples of results obtained from an implementation of the present disclosure.

FIG. 4 illustrates an example of a method for surveillance of a horizontal well according to some implementations of the present disclosure.

FIG. 5 is a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

Currently, array holdup or velocity measurements tend to be unreliable due to issues such as sticky bore hole, and emulsion flow. In such cases, Pulsed Neutron (PN) measurements may be taken to compensate for the missing array holdup/velocity data. However the acquired PN data are average measurements which are not sensitive to flow regime and fluid distribution in the borehole, while the array sensors are local measurements affected by flow regime structure. If the phase holdup is measured with a PN tool, only average values representing the measured flow area are available without details of the spatial distribution of phases.

The disclosed technology is directed to combining pulsed neuron measurement with spinner array measurement for inspection of reservoir surveillance. The disclosed technology can use the average phase holdup from PN measurement and create simulated APL (array production logging) holdups by identifying the location of interfaces (hydraulic diameter) between any two phases in stratified flow conditions. In some cases, the average phase holdup from PN measurement is combined with velocity distribution to create simulated APL holdups chart. Notably, the flow pattern can be stratified, which means phases can segregate with the heaviest phase on the low side and lightest phase on the high side of the flow area. This allows integration of the PN phase holdup results with APL measurements to facilitate calculation of phase flow rates. In order to implement the pseudo-APL holdup measurements into the existing production logging interpretation packages, a new array tool is created with more simulated sensors to allow these interfaces to be determined with greater certainty. The approach can be applied to a three phase flow or any combination of two phases, based on the measured PN data. The process can identify the location of interfaces (hydraulic diameter) between any two phases in stratified flow conditions.

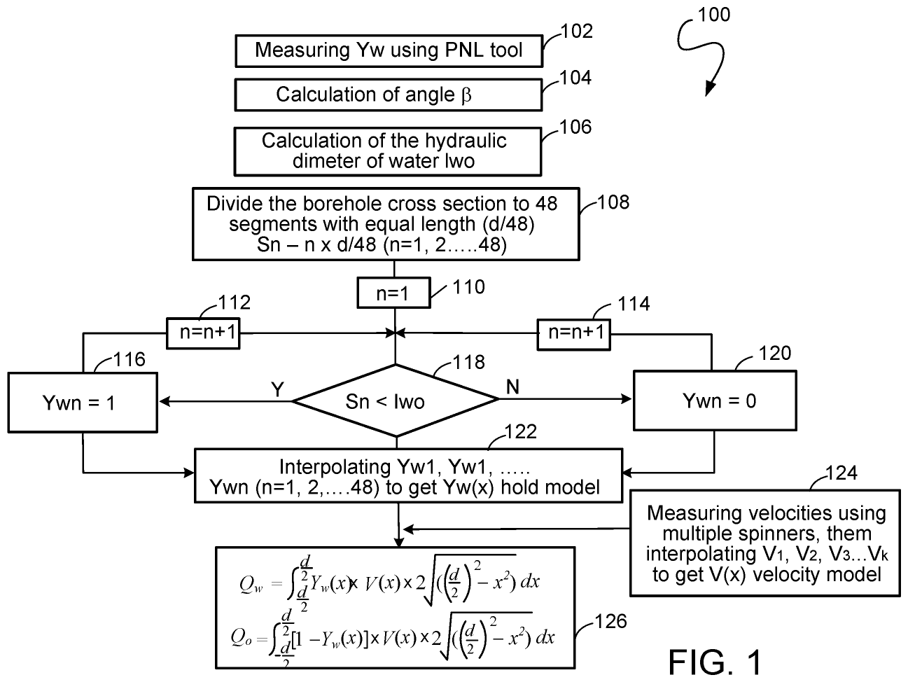

FIG. 1 shows an example of a flow chart 100 for converting the global holdup measurement into a more localized array holdup estimate and then combining the estimate with an array velocity measurements to determine the ratios of oil and water. Initially, the process measures water holdup Yw using a pulsed neutron tool (PNL) (102). For context, PNL measures the die-away time of a short-lived neutron pulse. PNL probes the formation with neutrons but detect gamma rays. For constant porosity, e.g., when the diameter of a well is known, the log will track water holdup (also known as water saturation) Y_{w}.

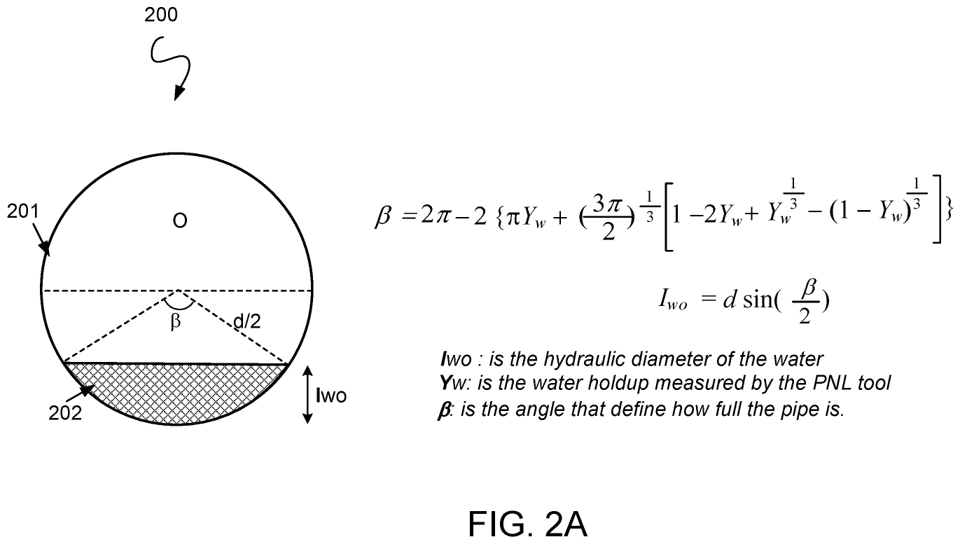

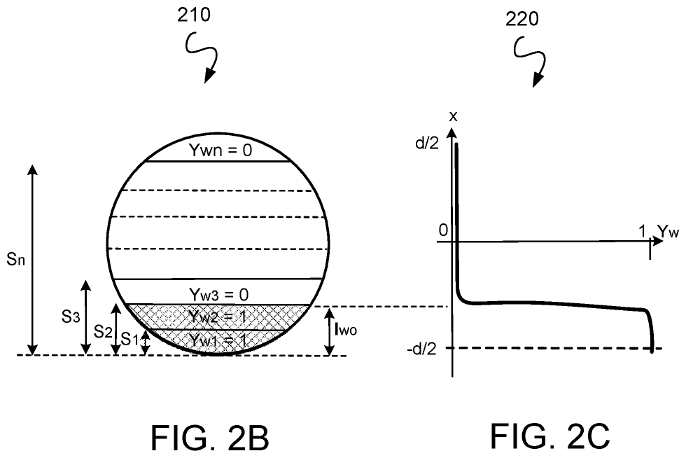

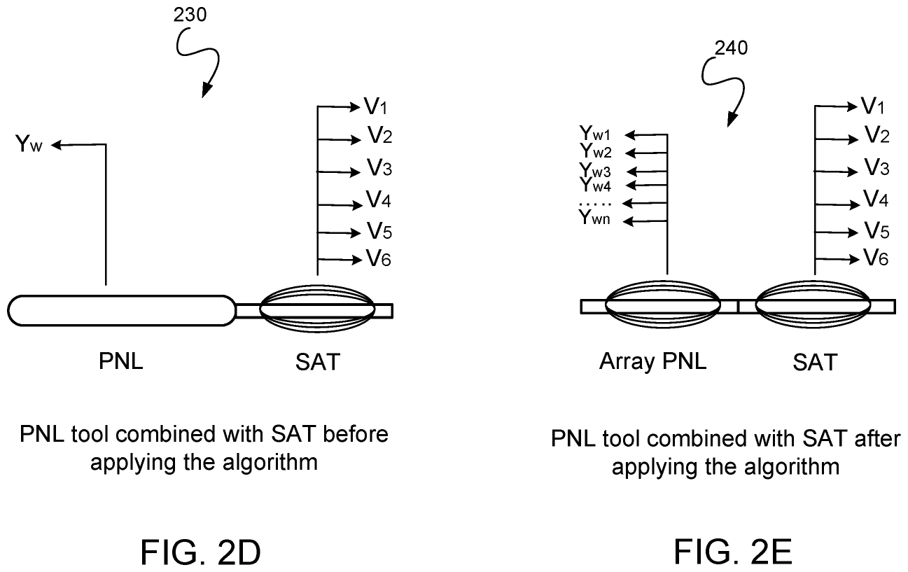

Further referring to FIGS. 2A to 2C, diagram 200 illustrates a water holdup 202 (“W”) towards a segment of well. The remainder of the wellbore is denoted “O” (for oil), as indicated by label 201. As illustrated, the angle β defines how full the pipe is, I_{wo} is the hydraulic diameter of water, Y_{w} is the water holdup measured from the PNL tool, and d is a diameter of the pipe. Still referring to FIG. 1, the method then calculates the angle β (104), for example, in accordance with the formula shown in FIG. 2A and based on the water holdup measured from the PNL tool. The method then calculates the hydraulic diameter of water I_{wo} (106), for example, in accordance with the formula shown in FIG. 2A and based on the calculated angle β and pipe diameter d.

The method then proceeds to convert the global water holdup measurement acquired from pulsed neutron tool (PNL) over the borehole cross section to an array holdup local measurements. The method proceeds to divide the borehole cross section to, for example, 48 segments with equal length (108) so that the segments are divided equally (d/48) and the segments (S) are indexed from 1 to 48. The method may start from the first segment S₁ (110) and proceed to determine whether the current segment height is lower than the water holdup I_{wo}. (118). If the segment height is lower than the water holdup I_{wo}, the method proceeds to log Y_{w} at this height as 1 (116), increments the indexing by 1 (112), and then retest whether the current segment height is lower than the water holdup I_{wo}. (118). If the segment height is not lower than the water holdup I_{wo}, the method proceeds to log Y_{w} at this height as 0 (120), increments the indexing by 1 (114), and then retest whether the current segment height is lower than the water holdup I_{wo}. (118). The interpolation between Y(x) values is non-leaner interpolation in which the fitted function yields 1 when the segment is below the interface and 0 when the segment is above the interface. The method may further interpolate Y_{w} for each height (from n=1 to 48) to obtain a Y_{w}(x) holdup model (122). By way of illustration, the workflow proceeds from the boxes 120 and 116 respectively to boxes 114 and 112 n times (n=48 in this case). After completing the loop, the workflow proceeds to box 122. Panel 210 of FIG. 2B illustrates the water holdup I_{wo} inside the pipe. At each respective segment (S₁, S₂, S₃, . . . , Sₙ), a corresponding Y_{w} is obtained. As shown in panel 220 of FIG. 2C, the cross-sectional Y_{w}(x) holdup model can be obtained from the estimates obtained from FIG. 2B.

Still referring to FIG. 1, the method may then obtain measured velocities using multiple spinners and then interpolate the measured velocities inside the pipe to match the location of the segments from the pulsed neutron tool estimations (124). For context, a spinner array tool may feature, for example, six miniature turbines deployed on bowspring arms, enabling discrete local fluid velocities to be obtained inside a wellbore.

Further referring to FIGS. 2D and 2E, pulsed neuron measurement yields a global measurement of water hold-up while spinner array measurement yields localized measurement of flow velocity. As illustrated in panel 230 of FIG. 2D, the global measurement of water hold-up from a pulsed neutron tool may not be reveal granular spatial information as the velocity measurements (total of six) from the spinner tool. By virtue of the disclosed method, the global holdup measurement can be converted into a more localized array holdup estimates that correspond to the locations of the measurements taken from the spinner array tool, as illustrated by panel 240 of FIG. 2E.

Returning to FIG. 1, the method may proceed to determine a quotient water Q_{w} and a quotient oil Qₒ (126). As illustrated, the quotient water Q_{w} can be determined by integrating the localized water hold-up estimate combined with the corresponding velocity estimates, while the quotient oil Qₒ can be determined by integrating the complement of the localized water hold-up estimate combined with the corresponding velocity estimates. The quotient water Q_{w} and the quotient oil Qₒ can be provided as feedback to an operator on a display device of a computing device, as measurements from the pulsed neutron tool and the spinner array tool are received, for example, as streaming of data.

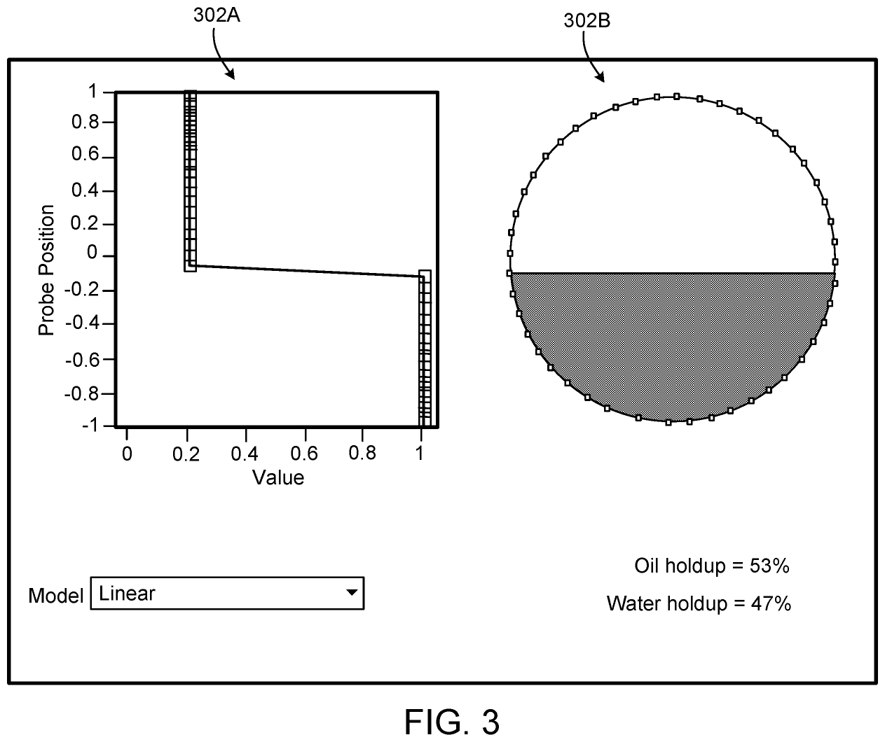

FIG. 3 demonstrates estimates obtained according to some implementations. Panel 302A shows an estimate of Yw across a diameter (3.958 in) of the wellbore at a depth of 7223.64 ft while panel 302B shows a cross-sectional view of the estimated oil phase and water phase at this depth. In particular, the oil holdup is estimated at 0.533 (top) while the water holdup is estimated at 0.467 (bottom).

In essence, the acquired pulse neutron (PN) measurements are average numbers from the entire region (e.g., a cross-section), which are not sensitive to flow regime and fluid distribution in the borehole, while the array sensors are local measurements affected by flow regime structure. If the phase holdup is measured with a PN tool, only average values representing the measured flow area are available without details of the spatial distribution of phases. If the flow is stratified, phases can be assumed to segregate with the heaviest phase on the low side and lightest phase on the high side of the flow area. This stratification allows integration of the pulsed neutron (PN) phase holdup results with array production logging (APL) measurements to facilitate calculation of phase flow rates. Implementations can interpret the combination of global and array measurements and add new service for production logging in horizontal wells. In particular, some examples can use the average phase holdup from PN measurement and create simulated APL holdups by identifying the location of interfaces (hydraulic diameter) between any two phases in stratified flow conditions. In other words, some examples can provide pseudo-APL holdup measurements by leveraging more simulated sensors to allow these interfaces to be determined with greater certainty. The implementations are applicable to a three phase flow or any combination of two phases, based on the measured PN data.

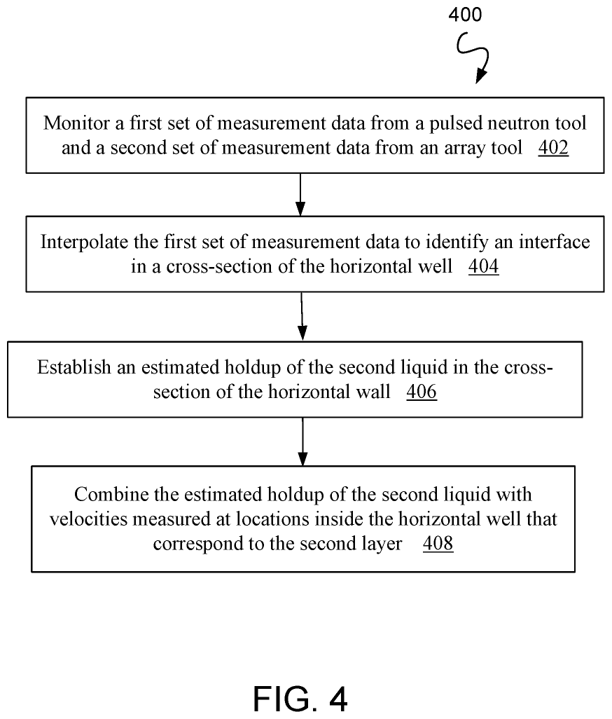

FIG. 4 is a flow chart 400 illustrating an example of a method for surveillance of a horizontal well according to some implementations. The horizontal well may be the sidetrack of a vertical bore. As commonly understood in the industry, the horizontal well does not need to be perfectly square, or square throughout the entire length. The method may monitor a first set of measurement data from a pulsed neutron tool and a second set of measurement data from an array tool (402). In some cases, the horizontal well includes a first liquid in a first layer and a second liquid in a second layer that is below the first layer. The first set of measurement data indicate a holdup of the second liquid globally inside the horizontal well, and the second set of measurement data show a plurality of velocities measured at a set of corresponding locations inside the horizontal well. In one example, the first liquid is the oil phase, and the second liquid is the aqueous phase, as illustrated in, for example, FIGS. 2A to 2E. The method may then interpolate the first set of measurement data to identify an interface in a cross-section of the horizontal well (404). The interface is the boundary between the first layer and the second layer, as illustrated in, for example, FIGS. 2A to 2E. In some case, the interpolation may include dividing the cross-section of the horizontal well into a plurality of segments; and fitting the first set of measurement data according to the plurality of segments such that the identified interface matches a profile of the first set of measurement data, as further explains an example of the interpolation. The plurality of segments may be evenly spaced. Based on the interface, the method may proceed to establish an estimated holdup of the second liquid in the cross-section of the horizontal wall (406). The method may further establish an estimated holdup of the first liquid in the cross-section of the horizontal well. The method may then proceed to combine the estimated holdup of the second liquid with velocities measured at locations inside the horizontal well that correspond to the second layer to generate a flow weighted estimate of the second liquid inside the horizontal well (408). The method may further combine the estimated holdup of the first liquid with velocities measured at locations inside the horizontal well that correspond to the first layer to generate a flow weighted estimate of the first liquid inside the horizontal well. The method may then supplement a production log with the flow weighted estimate of the second liquid inside the horizontal well and the flow weighted estimate of the first liquid inside the horizontal well. The method may supplement a production log with the flow weighted estimate of the second liquid inside the horizontal well alone. In some cases, the horizontal well further includes a third liquid in a third layer that is above the first layer or below the second layer. In these cases, the method may further include: interpolating the first set of measurement data to identify an interface, wherein the interface is either between the first layer and the third layer, or between the second layer and the third layer; based on the interface, establishing an estimated holdup of the third liquid in the cross-section of the horizontal well; and combining the estimated holdup of the third liquid with velocities measured at locations inside the horizontal well that correspond to the third layer to generate a flow weighted estimate of the third liquid inside the horizontal well. The array tool may include a spinner array tool with a multitude of sensors.

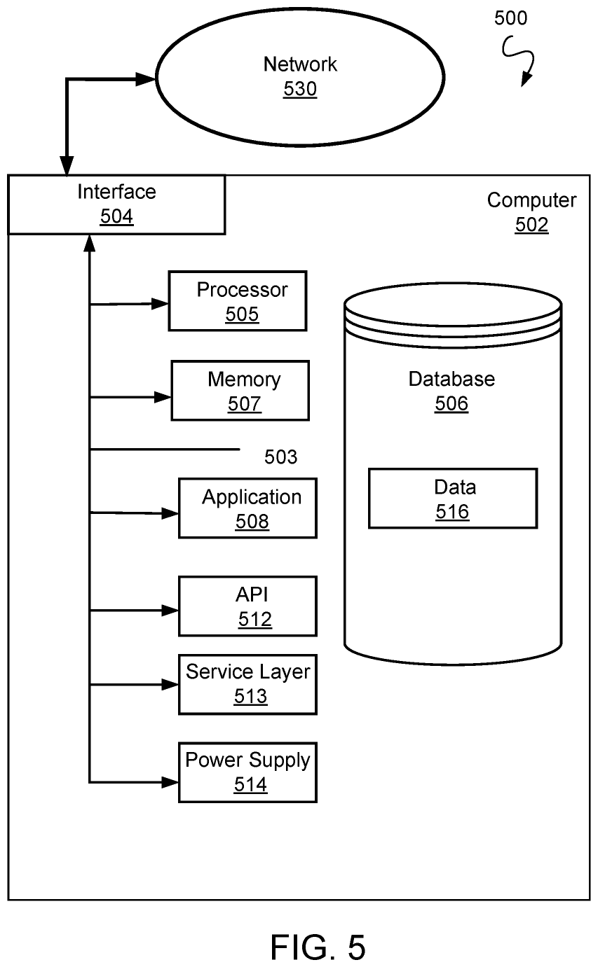

FIG. 5 is a block diagram illustrating an example of a computer system 500 used to provide computational functionalities associated with described algorithms, methods, functions, processes, flows, and procedures, according to an implementation of the present disclosure. The illustrated computer 502 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 502 can comprise a computer that includes an input device, such as a keypad, keyboard, touch screen, another input device, or a combination of input devices that can accept user information, and an output device that conveys information associated with the operation of the computer 502, including digital data, visual, audio, another type of information, or a combination of types of information, on a graphical-type user interface (UI) (or GUI) or other UI.

The computer 502 can serve in a role in a computer system as a client, network component, a server, a database or another persistency, another role, or a combination of roles for performing the subject matter described in the present disclosure. The illustrated computer 502 is communicably coupled with a network 530. In some implementations, one or more components of the computer 502 can be configured to operate within an environment, including cloud-computing-based, local, global, another environment, or a combination of environments.

The computer 502 is an electronic computing device operable to receive, transmit, process, store, or manage data and information associated with the described subject matter. According to some implementations, the computer 502 can also include or be communicably coupled with a server, including an application server, e-mail server, web server, caching server, streaming data server, another server, or a combination of servers.

The computer 502 can receive requests over network 530 (for example, from a client software application executing on another computer 502) and respond to the received requests by processing the received requests using a software application or a combination of software applications. In addition, requests can also be sent to the computer 502 from internal users, external or third-parties, or other entities, individuals, systems, or computers.

Each of the components of the computer 502 can communicate using a system bus 503. In some implementations, any or all of the components of the computer 502, including hardware, software, or a combination of hardware and software, can interface over the system bus 503 using an application programming interface (API) 512, a service layer 513, or a combination of the API 512 and service layer 513. The API 512 can include specifications for routines, data structures, and object classes. The API 512 can be either computer-language independent or dependent and refer to a complete interface, a single function, or even a set of APIs. The service layer 513 provides software services to the computer 502 or other components (whether illustrated or not) that are communicably coupled to the computer 502. The functionality of the computer 502 can be accessible for all service consumers using this service layer. Software services, such as those provided by the service layer 513, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 502, alternative implementations can illustrate the API 512 or the service layer 513 as stand-alone components in relation to other components of the computer 502 or other components (whether illustrated or not) that are communicably coupled to the computer 502. Moreover, any or all parts of the API 512 or the service layer 513 can be implemented as a child or a sub-module of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502. The interface 504 is used by the computer 502 for communicating with another computing system (whether illustrated or not) that is communicatively linked to the network 530 in a distributed environment. Generally, the interface 504 is operable to communicate with the network 530 and comprises logic encoded in software, hardware, or a combination of software and hardware. More specifically, the interface 504 can comprise software supporting one or more communication protocols associated with communications such that the network 530 or interface's hardware is operable to communicate physical signals within and outside of the illustrated computer 502.

The computer 502 includes a processor 505. Although illustrated as a single processor 505 in FIG. 5, two or more processors can be used according to particular needs, desires, or particular implementations of the computer 502. Generally, the processor 505 executes instructions and manipulates data to perform the operations of the computer 502 and any algorithms, methods, functions, processes, flows, and procedures as described in the present disclosure.

The computer 502 also includes a database 506 that can hold data for the computer 502, another component communicatively linked to the network 530 (whether illustrated or not), or a combination of the computer 502 and another component. For example, database 506 can be an in-memory, conventional, or another type of database storing data consistent with the present disclosure. In some implementations, database 506 can be a combination of two or more different database types (for example, a hybrid in-memory and conventional database) according to particular needs, desires, or particular implementations of the computer 502 and the described functionality. Although illustrated as a single database 506 in FIG. 5, two or more databases of similar or differing types can be used according to particular needs, desires, or particular implementations of the computer 502 and the described functionality. While database 506 is illustrated as an integral component of the computer 502, in alternative implementations, database 506 can be external to the computer 502. As illustrated, the database 506 holds the previously described data 516 including, for example, pulsed neutron measurement data, array production logging data, and flow measurement data (e.g., from spinner array tool).

The computer 502 also includes a memory 507 that can hold data for the computer 502, another component or components communicatively linked to the network 530 (whether illustrated or not), or a combination of the computer 502 and another component. Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 or similar or differing types can be used according to particular needs, desires, or particular implementations of the computer 502 and the described functionality. While memory 507 is illustrated as an integral component of the computer 502, in alternative implementations, memory 507 can be external to the computer 502.

The application 508 is an algorithmic software engine providing functionality according to particular needs, desires, or particular implementations of the computer 502, particularly with respect to functionality described in the present disclosure. For example, application 508 can serve as one or more components, modules, or applications. Further, although illustrated as a single application 508, the application 508 can be implemented as multiple applications 508 on the computer 502. In addition, although illustrated as integral to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion or management circuits (including recharging, standby, or another power management functionality). In some implementations, the power-supply 514 can include a power plug to allow the computer 502 to be plugged into a wall socket or another power source to, for example, power the computer 502 or recharge a rechargeable battery.

There can be any number of computers 502 associated with, or external to, a computer system containing computer 502, each computer 502 communicating over network 530. Further, the term “client,” “user,” or other appropriate terminology can be used interchangeably, as appropriate, without departing from the scope of the present disclosure. Moreover, the present disclosure contemplates that many users can use one computer 502, or that one user can use multiple computers 502.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for surveillance of a horizontal well, comprising:
monitoring a first set of measurement data from a pulsed neutron tool and a second set of measurement data from an array tool, wherein:
the horizontal well includes a first liquid in a first layer and a second liquid in a second layer that is below the first layer,
the first set of measurement data indicate a holdup of the second liquid globally inside the horizontal well, and
the second set of measurement data show a plurality of velocities measured at a set of corresponding locations inside the horizontal well; and
interpolating the first set of measurement data to identify an interface in a cross-section of the horizontal well, wherein the interface is between the first layer and the second layer;
based on the interface, establish an estimated holdup of the second liquid locally in the cross-section of the horizontal well; and
combining the estimated holdup of the second liquid with velocities measured at locations inside the horizontal well that correspond to the second layer to generate a flow weighted estimate of the second liquid inside the horizontal well.

2. The computer-implemented method of claim 1, further comprising:
based on the interface, establishing an estimated holdup of the first liquid in the cross-section of the horizontal well.

3. The computer-implemented method of claim 2, further comprising:
combining the estimated holdup of the first liquid with velocities measured at locations inside the horizontal well that correspond to the first layer to generate a flow weighted estimate of the first liquid inside the horizontal well.

4. The computer-implemented method of claim 3, further comprising:
supplementing a production log with the flow weighted estimate of the second liquid inside the horizontal well and the flow weighted estimate of the first liquid inside the horizontal well.

5. The computer-implemented method of claim 1, further comprising:
supplementing a production log with the flow weighted estimate of the second liquid inside the horizontal well.

6. The computer-implemented method of claim 1, wherein interpolating the first set of measurement data comprises:
dividing the cross-section of the horizontal well into a plurality of segments; and
fitting the first set of measurement data according to the plurality of segments such that the interface matches a profile of the first set of measurement data.

7. The computer-implemented method of claim 6, wherein the plurality of segments are evenly spaced and wherein said fitting includes at least one non-linear fitting.

8. The computer-implemented method of claim 1, wherein the horizontal well further includes a third liquid in a third layer that is above the first layer or below the second layer.

9. The computer-implemented method of claim 8, further comprising:
interpolating the first set of measurement data to identify an interface, wherein the interface is either between the first layer and the third layer, or between the second layer and the third layer;
based on the interface, establishing an estimated holdup of the third liquid in the cross-section of the horizontal well; and
combining the estimated holdup of the third liquid with velocities measured at locations inside the horizontal well that correspond to the third layer to generate a flow weighted estimate of the third liquid inside the horizontal well.

10. The computer-implemented method of claim 1, wherein the array tool comprises a spinner array tool with a multitude of sensors.

11. A computer system comprising one or more processors configured to perform operations of:
monitoring a first set of measurement data from a pulsed neutron tool and a second set of measurement data from an array tool, wherein:
a horizontal well includes a first liquid in a first layer and a second liquid in a second layer that is below the first layer,
the first set of measurement data indicate a holdup of the second liquid globally inside the horizontal well, and
the second set of measurement data show a plurality of velocities measured at a set of corresponding locations inside the horizontal well, and
interpolating the first set of measurement data to identify an interface in a cross-section of the horizontal well, wherein the interface is between the first layer and the second layer;
based on the interface, establish an estimated holdup of the second liquid locally in the cross-section of the horizontal well; and
combining the estimated holdup of the second liquid with velocities measured at locations inside the horizontal well that correspond to the second layer to generate a flow weighted estimate of the second liquid inside the horizontal well.

12. The computer system of claim 11, wherein the operations further comprise:
based on the interface, establishing an estimated holdup of the first liquid in the cross-section of the horizontal well.

13. The computer system of claim 12, wherein the operations further comprise:
combining the estimated holdup of the first liquid with velocities measured at locations inside the horizontal well that correspond to the first layer to generate a flow weighted estimate of the first liquid inside the horizontal well.

14. The computer system of claim 13, wherein the operations further comprise:
supplementing a production log with the flow weighted estimate of the second liquid inside the horizontal well and the flow weighted estimate of the first liquid inside the horizontal well.

15. The computer system of claim 11, wherein the operations further comprise:
supplementing a production log with the flow weighted estimate of the second liquid inside the horizontal well.

16. The computer system of claim 11, wherein interpolating the first set of measurement data comprises:
dividing the cross-section of the horizontal well into a plurality of segments; and
fitting the first set of measurement data according to the plurality of segments such that the interface matches a profile of the first set of measurement data.

17. The computer system of claim 16, wherein the plurality of segments are evenly spaced and wherein said fitting includes at least one non-linear fitting.

18. The computer system of claim 11, wherein the horizontal well further includes a third liquid in a third layer that is above the first layer or below the second layer.

19. The computer system of claim 18, wherein the operations further comprise:
interpolating the first set of measurement data to identify an interface, wherein the interface is either between the first layer and the third layer, or between the second layer and the third layer;
based on the interface, establishing an estimated holdup of the third liquid in the cross-section of the horizontal well; and
combining the estimated holdup of the third liquid with velocities measured at locations inside the horizontal well that correspond to the third layer to generate a flow weighted estimate of the third liquid inside the horizontal well.

20. The computer system of claim 11, wherein the array tool comprises a spinner array tool with a multitude of sensors.
